(19) United States
(12) Patent Application Publication
(10) Pub. No.: US 2022/0129023 A1
(43) Pub. Date: Apr. 28, 2022

(54) MAINTAINING INFLATABLE PRODUCT PRESSURE

(71) Applicant: Gibbons Fans Limited, Colchester (GB)

(72) Inventors: Scott ABBOTT, Colchester (GB); William TAYLOR, Alloway (GB)

(21) Appl. No.: 17/511,961

(22) Filed: Oct. 27, 2021

(30) Foreign Application Priority Data
Oct. 28, 2020 (GB) GB 2017107.0
Jul. 20, 2021 (GB) GB2110428.6

(51) Int. Cl. G05D 16/20; G08B 21/18

(52) U.S. Cl. CPC G05D 16/2066; A63H 33/008; G08B 21/182

(57) ABSTRACT

A method of maintaining the internal pressure of an inflatable product utilises control apparatus. An air flow generator, operated by a motor, supplies a flow of air internally to a connected inflatable product. A sensor arrangement monitors the internal pressure of the connected inflatable product and a motor controller adjusts the speed of the motor depending upon the monitored pressure.

This invention relates to a method of maintaining the internal pressure of an inflatable product and to a control apparatus for maintaining the internal pressure of an inflatable product. The terms “inflatable product”, “inflatable” and “product” shall be used herein interchangeably.

There are many forms of inflatable product and these tend to fall into one of two categories: continuous airflow or sealed. The first type (continuous airflow) allows air to escape from seams formed in the product and are supplied with a consistent airflow to maintain the internal pressure and thereby keep the product in an inflated configuration. The second type (sealed) are inflated with a volume of air and then sealed to prevent the air from escaping. The present invention is concerned with the first type of inflatable product, namely continuous airflow. Such inflatable products include, but are not limited to, inflatable amusement attractions, such as bouncy castles, inflatable slides, inflatable obstacle courses, etc., as well as inflatable buildings, inflatable advertising, display or movie screens, inflatable safety barriers, etc., and other inflatable products requiring a continuous airflow to remain suitably inflated. Typically, a fan or blower serves to inflate the product with a continuous airflow.

There are several safety issues associated with inflatable products. For example, existing methods and apparatus do not account for unwanted variation in the internal pressure of the inflatable product. As a result, serious safety consequences can occur and have occurred. An inflatable product which is underinflated is structurally unstable and can collapse, and this can cause harm and/or injury to any person or persons (e.g. children) located on or near to the inflatable product at the time of collapse. Whilst less common, an overinflated product can also be extremely dangerous as this can cause an inflatable potentially to tear, lose pressure and collapse or even to explode.

When inflated and used outside, it is also important for all inflatable products, such as those discussed above, to be properly anchored to the ground. The effect of strong winds on an improperly anchored inflatable, or indeed on a correctly anchored inflatable in extremely windy weather conditions, can be catastrophic. In such conditions, inflatables have been known to become unstable and blown long distances, in some instances with people trapped inside.

It is a principle aim of the present invention to provide a method and apparatus for maintaining the internal pressure of an inflatable product and which serves to address at least some of the above-identified problems.

According to an aspect of this invention, there is provided a method of maintaining the internal pressure of an inflatable product, utilising control apparatus, wherein: an air flow generator, operated by a motor, supplies a flow of air internally to a connected inflatable product; a sensor arrangement monitors the internal pressure of the connected inflatable product: and a motor controller adjusts the speed of the motor depending upon the monitored pressure.

According to another aspect of this invention, there is provided control apparatus for maintaining the internal pressure of an inflatable product, the control apparatus comprising: an air flow generator for supplying a flow of air internally to a connected inflatable product, the airflow generator having a motor for operation thereof; a sensor arrangement configured to monitor the internal pressure of the connected inflatable product; and a motor controller arranged to adjust the speed of the motor depending upon the monitored pressure.

The inflatable product can be any form of inflatable product capable of receiving a continuous flow of air to maintain it in an inflated condition. This includes, but is not limited to, inflatable amusement attractions, such as bouncy castles, inflatable slides, inflatable obstacle courses, etc., as well as inflatable buildings, inflatable advertising, display or movie screens, inflatable safety barriers, etc., and other inflatable products requiring a continuous airflow. Preferably the air flow generator is a fan or a blower or another device capable of providing a flow of air to a connected inflatable product.

Safety is paramount and, by adjusting the pressure within the inflatable device, under-inflation and indeed over-inflation can be avoided. For example, if the monitored pressure decreases, the speed of the motor may be increased to raise the pressure. Similarly, if the monitored pressure increases, the speed of the motor may be decreased to lower the pressure. The method in effect may operate as a feedback loop, ensuring consistent pressure is provided to the inflatable product.

The ability of the control apparatus to maintain the pressure within a connected inflatable product, allows versatility with regard to the use of that control apparatus to inflate different inflatable products and with regard to the size and air flow capabilities of the air flow generator. In effect, the same control apparatus can be used for many different inflatable products and many different air flow generators can be used for the same inflatable product since the speed of the motor, and thereby the pressure of the connected inflatable product, will be monitored and appropriately adjusted by the control apparatus. For example, a smaller inflatable and/or an inflatable having a lower rate of air escape and/or a larger/more capable air flow generator, can reach operating pressure more quickly, and then the speed of the motor can be reduced to a lower level accordingly, for example so as to prevent overinflation, to save energy, and/or to maintain the safe operating pressure of the inflatable. On the other hand, a larger inflatable and/or an inflatable having a higher rate of air escape and/or a smaller/less capable air flow generator, will reach operating pressure more slowly, and the speed of the motor can be maintained at a higher level for longer. The air flow capabilities of an air flow generator is typically dependent on the power supplied thereto. The method and apparatus of the present invention also accordingly facilitates the use of the same control apparatus with varying voltages and/or frequencies of power supply. Typically, the voltages will range from 85V-265V and/or will be at a frequency of 50 Hz or 60 Hz. Thus, the control apparatus may be able to operate when supplied with any voltage in the range 85V-265V and/or when supplied with a voltage having a frequency of 50 Hz and/or when supplied with a voltage having a frequency of 60 Hz.

Moreover, considerable energy can be conserved, and cost savings achieved over existing arrangements by the ability of the present invention to alter the speed of the motor in accordance with the air flow requirements of the specific inflatable product.

The pressure may be indirectly or, less preferably directly, monitored. Preferably the sensor arrangement monitors the internal pressure of the connected inflatable product by monitoring the torque and/or speed of the motor. By monitoring the torque and/or speed of the motor and adjusting the speed of the motor accordingly, the operation of the control apparatus need not be directly dependent solely upon the electrical power output of the power supply for the control apparatus. The power supply will, in the majority of cases, comprise an electric (e.g. AC or DC) power source and the electric power supplied to the control apparatus is likely to vary somewhat due to voltage/current changes and/or voltage/current phase shifts. By monitoring the torque and/or speed and adjusting the speed of the motor accordingly, the problem of varying electrical power can be largely circumvented. The motor of the air flow generator is preferably an electric motor, which may be powered by an AC or DC power supply.

Parameters of the motor may be measured directly and the torque may be determined (e.g. calculated) therefrom. For example, the voltage supplied to the motor, current supplied to the motor, and/or motor speed may be measured directly, and the torque may be determined (e.g. calculated) therefrom. For example, the torque may be calculated using the equation T=(V*I*E)/ω, where V is the voltage supplied to the motor, I is the current supplied to the motor, E is the motor efficiency (power out/power in), and ω is the motor speed (angular speed in rad/s). Other measurements and/or relationships (equations and/or look-up tables) may be used to determine the torque as desired. This allows for continuous measurements and takes into account variabilities in the power being supplied by the source.

Operation of the control apparatus to vary the speed of the motor in response to the monitored pressure of the connected inflatable product is preferably carried out autonomously. The pressure to be maintained may be predetermined, autonomously selected, and/or manually selected. The motor controller may include a microprocessor programmed to automatically and continuously monitor the pressure within the inflatable product and to adjust the speed of the motor accordingly. The microprocessor will ideally be pre-programmed with acceptable safe pressure parameters which may vary depending upon the inflatable product being inflated.

In embodiments, the speed of the motor may selectively or automatically be reduced to maintain a lower pressure in the inflatable product. The control apparatus may have a “low energy mode” which can be selected by the operator of the inflatable product to establish a lower pressure to be maintained. This will serve to reduce the speed of the motor and to reduce the supply of air to the inflatable product. This mode may be selected, for example, where the inflatable product is an amusement attraction, such as a bouncy castle, inflatable slide, inflatable obstacle course, etc., and in instances where the inflatable is not being used (e.g. there is no one on the inflatable product) but it is preferable to maintain the structural integrity thereof. For safety purposes, preferably the control apparatus includes an alert to provide an audio and/or visual indication that the low energy mode has been initiated. Such an alert may be set to trigger at predefined intervals, such as every 30 seconds. Even more preferably, the control apparatus may continue to monitor the pressure of the inflatable (e.g. by monitoring the torque and/or speed of the motor) when in low energy mode and, if the pressure increases (e.g. torque increases and/or speed decreases), may immediately increase the speed of the motor to increase the supply of air to the inflatable product, e.g. so that it is inflated to a safe operating pressure as quickly as possible. An increase in torque or decrease in speed of the motor during low energy mode is typically caused by back pressure, as a result of someone climbing on to the inflatable. The low energy mode may be automatically turned off and normal operation of the control apparatus resumed if use of the inflatable is initiated (e.g. if someone climbs on to the inflatable product). In such an instance the control apparatus may include an alarm, e.g. distinct from the alert discussed above, to provide an audio and/or visual indication to notify the operator when there is a change to the status of the energy mode. These features are considered to be particularly advantageous in their own right, and not merely in combination with the other aspects and embodiments disclosed herein.

Thus, according to another aspect of this invention, there is provided a method of maintaining the internal pressure of an inflatable product, utilising control apparatus, wherein: an air flow generator, operated by a motor, supplies a flow of air internally to a connected inflatable product; and a motor controller adjusts the speed of the motor, wherein the speed of the motor is selectively or automatically reduced to maintain a lower pressure in the inflatable product in a lower energy mode and is selectively or automatically increased to maintain a higher pressure in the inflatable product in a higher energy mode.

Similarly, according to another aspect of this invention, there is provided control apparatus for maintaining the internal pressure of an inflatable product, the control apparatus comprising: an air flow generator for supplying a flow of air internally to a connected inflatable product, the air flow generator having a motor for operation thereof; and a motor controller arranged to adjust the speed of the motor, wherein the speed of the motor is selectively or automatically reduced to maintain a lower pressure in the inflatable product in a lower energy mode and is selectively or automatically increased to maintain a higher pressure in the inflatable product in a higher energy mode.

As discussed above, a sensor arrangement may monitor the internal pressure of the connected inflatable product and the motor controller may also adjust the speed of the motor depending upon the monitored pressure. Thus, the control apparatus may include a sensor arrangement configured to monitor the internal pressure of the connected inflatable product and the motor controller may be arranged also to adjust the speed of the motor depending upon the monitored pressure.

As with all electrical equipment, when the control apparatus is initially powered, it causes an inrush current to be drawn from the power supply and this can cause electrocution protection circuitry (e.g. an RCD of a consumer unit) to trip on start up. Preferably, in any of the aspects or embodiments disclosed herein, the current drawn by the motor is limited upon start up and the speed of the motor is accelerated until the air flow generator is operating at a predetermined maximum speed. The control apparatus may include an inrush current limiter to achieve this. These embodiments can help to prevent electrocution protection circuitry from tripping on start up.

Preferably, the control apparatus also includes a sensor for monitoring windspeed. This sensor may be an anemometer or other windspeed monitoring device that can be mounted at an appropriate location relative to the inflatable product, e.g. on the control apparatus or on the inflatable product itself. The motor controller may be configured to initiate an alert if the monitored windspeed is beyond a set threshold. The alert may be a visual and/or audio alarm. The threshold will be selected based upon safety guidelines concerning windspeed. If the windspeed is too high this can cause the inflatable product to become unstable which could have catastrophic effects. In the interests of safety, the provision of an alert rather than an automatic shutdown is preferable in order to ensure that the inflatable is evacuated before the inflatable is deflated.

To provide greater versatility, the control apparatus of the present invention may also include additional sensors configured to monitor other operational states and/or parameters including one or more of: failure of the air flow generator, power supply failure, motor and/or motor controller temperature. The control apparatus may include one or more visual and/or audio alerts to provide information concerning the operational state and/or parameters.

The control apparatus may comprise a casing for housing the air flow generator, motor, sensor arrangement, motor controller, etc. In this way, the apparatus is protected by the casing against damage or the ingress of dirt or debris. This arrangement also avoids potential problems due to human interference.

The control apparatus of the present invention may further comprise a control panel. The control panel may be configured to provide a visual and/or audio indication of the status of the control apparatus. Such information may be provided by an LED to signal a status, such as a warning, e.g. an unsafe event or component failure and/or by a written message, such as the current specific speed of the motor or pressure of the inflatable. The control panel may alternatively or additionally allow manual control of the pressure and/or speed of the air flow generator. The control apparatus (e.g. control panel) may be configured to connect wirelessly to an external device, such as a mobile computing device (mobile phone, smartwatch, tablet computer and/or laptop computer) and/or server (e.g. which provides a cloud service). The wireless connection may be by way of Bluetooth, Wi-Fi, radio, cellular or other wireless protocols, for example. To achieve this the control apparatus (e.g. control panel) may include a transceiver.

In some embodiments, the inflatable product may be inflated using plural air flow generators as described herein. In these embodiments, each air flow generator may be operated by a motor, sensor arrangement and/or motor controller in a manner as described herein. The same control apparatus or a respective control apparatus may be used for the plural air flow generators.

By way of example only, an embodiment of this invention will now be described in detail, with reference being made to the accompanying drawings in which:—

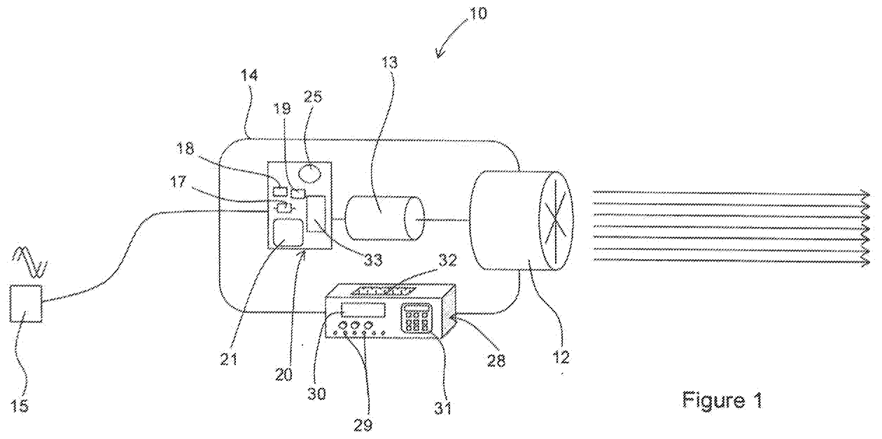

FIG. 1 is a simplified illustration of the control apparatus according to an embodiment of the present invention; and

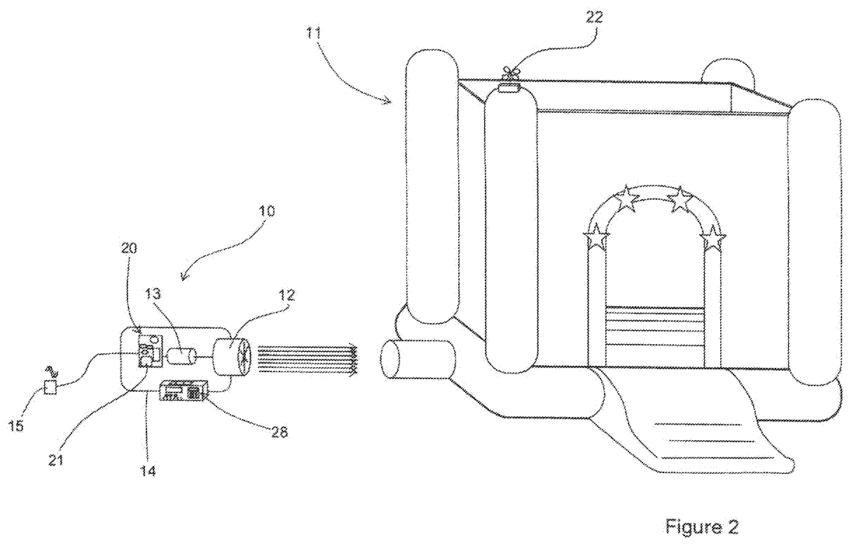

FIG. 2 is a perspective view of the apparatus of FIG. 1 ready for use on an inflatable bouncy castle.

Referring to both figures there is shown control apparatus 10 configured to supply air to an inflatable product. In this embodiment, the inflatable product is a bouncy castle 11 but in other embodiments various other inflatable products, as discussed above, could be supplied with air in a similar manner. The control apparatus 10 includes an air flow generator. In this embodiment, the air flow generator is in the form of a fan 12. The fan 12 is operated by an electric motor 13 and these are housed within a casing 14. An AC or DC power source 15 is arranged to supply power to the control apparatus 10. A generator (not shown) may alternatively be used and the control apparatus 10 is capable of use therewith. To facilitate this, the control apparatus 10 includes a resistor 17 to dissipate excess energy. This will serve to protect the internal components should too much energy be generated.

A PCB 20 is mounted in the casing 14 and is configured to communicate with the power source 15 and with the fan motor 13. The PCB 20 contains various sensors 18, 19 arranged to measure and monitor various parameters of the control apparatus 10, including the motor speed, motor torque, current used by the motor 13, input voltage to the PCB 20 and temperature of both the PCB 20 and the motor 13.

A motor controller in the form of a microprocessor 21 is also provided on the PCB 20 and this is programmed to indirectly monitor the pressure within the bouncy castle 11 and to adjust the speed of the motor 13 in response thereto. The microprocessor 21 may, for example, use the motor speed, voltage and/or current values obtained by the sensors 18, 19 provided on the PCB 20 to establish the torque. There is a relationship between the pressure in the bouncy castle 11 and the torque of the motor 13, and the microprocessor 21 uses this information to determine whether the speed of the fan 12 needs to be increased or decreased. If the torque, and thus pressure, is too high, then the speed of the fan 12 is reduced. If the torque, and thus pressure, is too low, then the speed of the fan 12 is increased. This means that operation of the control apparatus 10 is not directly dependent solely on the supply voltage and frequency, and this allows the control apparatus 10 to maintain a desired air pressure for a variety of different inflatables and when powered using a variety of supply voltages and/or frequencies.

If the windspeed value is too high the bouncy castle 11 can become unstable. The control apparatus 10 is also configured to receive information from an external sensor for monitoring windspeed, in this embodiment in the form of an anemometer 22 mounted on the bouncy castle 11. The microprocessor 21 is configured to initiate an alert if the monitored windspeed is beyond a set threshold. The alert may be a visual and/or audio alarm. The threshold will be selected based upon safety guidelines concerning windspeed.

The control apparatus 10 also includes a “low energy mode” which consumes less electrical energy and can be selected by the operator of the bouncy castle 11 to establish a lower pressure value to be maintained. This will serve to reduce the speed of the motor 13 and to reduce the supply of air to the inflatable product. This mode may be selected where the inflatable product is an amusement attraction, such as a bouncy castle 11, inflatable slide, inflatable obstacle course, etc., and in instances where the inflatable is not being used (e.g. no one is on the inflatable) but it is preferable to maintain the structural integrity thereof. The control apparatus 10 includes an alert in the form of a speaker 25 to provide an audio indication that the low energy mode has been initiated. The alert is triggered at predefined intervals of every 30 seconds. An increase in torque of the motor 13 during low energy mode tends to indicate that someone has climbed on to the bouncy castle 11. The control apparatus 10 will continue to monitor the torque of the motor 13 when in low energy mode and, if the torque increases, will immediately increase the speed of the motor 13 to increase the supply of air to the bouncy castle 11, so that it is inflated to a safe operating pressure as quickly as possible. The speaker 25 of the control apparatus 10 is set to trigger so as to notify the operator when there is a change to the status of the energy mode.

The control apparatus 10 operates in one of two further modes. The first is autonomous mode and the second is in user-operated mode.

In autonomous mode, the control apparatus 10 operates automatically without user input. To help to prevent any electrocution protection circuitry from tripping on start up, the apparatus 10 will initiate a soft start to limit the inrush current and accelerate the fan 12 up to a predetermined maximum speed in the range 2800 rpm to 4000 rpm. The maximum current drawn during start-up is 14 amps. When the fan 12 has accelerated up to full speed, the apparatus 10 will monitor the various parameters and adjust fan speed as detailed above and at the same time monitor the motor for any failure modes.

Failure modes include the following: locked rotor, over/under voltage, power failure (determined by monitoring motor speed), over/under current, excessive torque on the motor 13, under speed of the motor 13, failed PCB 20 and/or motor 13, over torque/under torque, high temperature, etc.

In the event of the following failure modes, the microprocessor 21 will shut down the fan motor 13 or the fan 12 will not start if not already running: locked rotor, over/under voltage (i.e. if used on a generator and the resistor is not installed), power failure (this will shut down the fan 12), failed PCB 20/motor 13, zero speed of the motor 13 and high temperature of motor 13 and PCB 20.

In the event of the following failure modes the microprocessor 21 will adjust the speed of the fan 12 to attempt to compensate: excessive torque on the motor 13 (the microprocessor 21 shall reduce the motor speed), under speed of the motor 13 (microprocessor 21 shall attempt to speed up the motor 13).

In the event of the other failure modes occurring, in order to try to maintain a safe operating pressure, the fan 12 will continue to run until the motor 13 fails or the microprocessor 21 fails.

In user-operated mode, use is made of a control panel 28 which is designed to attach to the casing 14 of the control apparatus 10. The control panel 28 is configured to provide a visual indication of the status of the features of the control apparatus 10. The panel 28 includes a series of LEDs 29 to signal a status, such as a warning, e.g. an unsafe event or component failure and/or a text screen 30 to provide a written message, such as the present speed of the motor 13 or pressure of the bouncy castle 11. Additionally, the control panel 28 may include a touch panel 31 to allow manual control of the speed of the fan 12. The control panel 28 includes a speaker 32 to provide audio alerts to the operator relating to particular events, as specified above.

The PCB 20 of the control panel 28 also includes a transceiver 33 to allow the control apparatus 10 to connect wirelessly to an external device, such as a mobile computing device (mobile phone, smartwatch, tablet computer and/or laptop computer) and/or server (e.g. which provides a cloud service), by Bluetooth, Wi-Fi, radio, cellular or other wireless protocols.

The ability of embodiments of the present invention to monitor operation of the control apparatus and to alter the speed of the fan in response thereto provides significant advances in the field of inflatable products. Embodiments of the present invention further enable the operator to be alerted to unsafe conditions, which will then allow the operator to take appropriate action to improve safety and reduce the likelihood of accidents occurring.

1. A method of maintaining the internal pressure of an inflatable product, utilising control apparatus, wherein: an air flow generator, operated by a motor, supplies a flow of air internally to a connected inflatable product; a sensor arrangement monitors the internal pressure of the connected inflatable product; and a motor controller adjusts the speed of the motor depending upon the monitored pressure.

2. A method as claimed in claim 1, wherein the sensor arrangement monitors the internal pressure of the connected inflatable product by monitoring the torque and/or speed of the motor.

3. A method as claimed in claim 2, wherein parameters of the motor are measured and the torque determined therefrom.

4. A method as claimed in claim 1 wherein operation of the control apparatus is autonomous.

5. A method as claimed in claim 1, wherein the speed of the motor is selectively or automatically reduced to maintain a lower pressure in the inflatable product in a lower energy mode and is selectively or automatically increased to maintain a higher pressure in the inflatable product in a higher energy mode.

6. A method as claimed in claim 5, wherein the control apparatus monitors the pressure of the inflatable product when in the lower energy mode and, if the pressure increases, increases the speed of the motor to increase the supply of air to the inflatable product.

7. A method of maintaining the internal pressure of an inflatable product, utilising control apparatus, wherein: an air flow generator, operated by a motor, supplies a flow of air internally to a connected inflatable product; and a motor controller adjusts the speed of the motor, wherein the speed of the motor is selectively or automatically reduced to maintain a lower pressure in the inflatable product in a lower energy mode and is selectively or automatically increased to maintain a higher pressure in the inflatable product in a higher energy mode.

8. A method as claimed in claim 7, wherein the control apparatus monitors the pressure of the inflatable product when in the lower energy mode and, if the pressure increases, increases the speed of the motor to increase the supply of air to the inflatable product.

9. A method as claimed in claim 1, wherein, the current drawn by the motor is limited upon start up and the speed of the motor is accelerated until the air flow generator is operating at a predetermined maximum speed.

10. A method as claimed in claim 1, wherein the control apparatus includes a sensor for monitoring windspeed and the motor controller initiates an alert if the monitored windspeed is beyond a set threshold.

11. A method as claimed in claim 1, wherein the control apparatus includes additional sensors which monitor other operational states and/or parameters including one or more of: failure of the air flow generator, power supply failure, motor and/or motor controller temperature.

12. A method as claimed in claim 11, wherein an alert is initiated if the value of an operational parameter falls outside a predetermined value.

13. A method as claimed in claim 1, wherein the control apparatus is connected wirelessly to an external device.

14. A method as claimed in claim 1, wherein the control apparatus operates when supplied with any voltage in the range 85V-265V and/or when supplied with a voltage having a frequency of 50 Hz and/or when supplied with a voltage having a frequency of 60 Hz.

15. Control apparatus for maintaining the internal pressure of an inflatable product, the control apparatus comprising: an air flow generator for supplying a flow of air internally to a connected inflatable product, the air flow generator having a motor for operation thereof; a sensor arrangement configured to monitor the internal pressure of the connected inflatable product; and a motor controller arranged to adjust the speed of the motor depending upon the monitored pressure.

16. Control apparatus as claimed in claim 15, wherein the speed of the motor is selectively or automatically reduced to maintain a lower pressure in the inflatable product in a lower energy mode and is selectively or automatically increased to maintain a higher pressure in the inflatable product in a higher energy mode.

17. Control apparatus as claimed in claim 16, wherein the control apparatus monitors the pressure of the inflatable product when in the lower energy mode and, if the pressure increases, increases the speed of the motor to increase the supply of air to the inflatable product.

18. Control apparatus for maintaining the internal pressure of an inflatable product, the control apparatus comprising: an air flow generator for supplying a flow of air internally to a connected inflatable product, the air flow generator having a motor for operation thereof; and a motor controller arranged to adjust the speed of the motor, wherein the speed of the motor is selectively or automatically reduced to maintain a lower pressure in the inflatable product in a lower energy mode and is selectively or automatically increased to maintain a higher pressure in the inflatable product in a higher energy mode.

19. Control apparatus as claimed in claim 18, wherein the control apparatus monitors the pressure of the inflatable product when in the lower energy mode and, if the pressure increases, increases the speed of the motor to increase the supply of air to the inflatable product.

20. Control apparatus as claimed in claim 15, further comprising a user operable control panel to allow manual adjustment of the speed of the motor.
